(19) United States
(12) Patent Application Publication
(10) Pub. No.: US 2021/0065112 A1
(43) Pub. Date: Mar. 4, 2021

(54) ORDER LOGISTICS CALCULATOR

(71) Applicant: NCR Corporation, Atlanta, GA (US)

(72) Inventors: Zachary Taylor Lasater, Perry, GA (US); Ankit Madhusudan Amin, Snellville, GA (US); Gina Torcivia Bennett, Lawrenceville, GA (US); Kip Oliver Morgan, Atlanta, GA (US)

(21) Appl. No.: 16/557,047

(22) Filed: Aug. 30, 2019

(51) Int. Cl. G06Q 10/08

(52) U.S. Cl. CPC G06Q 10/08355; G06Q 10/08345; G06Q 10/0833

(57) ABSTRACT

Various embodiments herein each include at least one of systems, methods, and software of order logistics calculators. Such calculators are implemented to determine feasible logistic solutions for product order deliveries. One method embodiment includes receiving, via a network from a computing device of a customer, order data including data identifying products for purchase and delivery to the customer and then determining at least one possible delivery option. A delivery option may be determined by identifying a possible delivery location based on customer calendar schedule data and determining an estimated delivery time from a shipping location to the possible delivery location. The method of this embodiment may then output, via the network to the computing device of the customer, data identifying at least one possible delivery location and a respective delivery time and further request customer acceptance input with regard to a possible delivery location and respective delivery time.

### BACKGROUND INFORMATION

Recent trends in the retail market show that more and more consumers are stepping away from in-store shopping. Thus, consumers are shopping online through mobile devices and websites. Most brick-and-mortar stores are not able keep pace with demands of these consumers, such as rapid order fulfillment.

### SUMMARY

Various embodiments herein each include at least one of systems, methods, and software of order logistics calculators. Such calculators are implemented to determine feasible logistic solutions for product order deliveries.

One embodiment, in the form of a method, includes receiving, via a network from a computing device of a customer, order data including data identifying products for purchase and delivery to the customer and then determining at least one possible delivery option. A delivery option may be determined by identifying a possible delivery location based on customer calendar schedule data and determining an estimated delivery time from a shipping location to the possible delivery location. The method of this embodiment may then output, via the network to the computing device of the customer, data identifying at least one possible delivery location and a respective delivery time and further request customer acceptance input with regard to a possible delivery location and respective delivery time.

Another method embodiment includes receiving, via a network from a computing device of a customer, order data including data identifying products for purchase and delivery to the customer and determining at least one delivery option. A delivery option is identified, in some embodiments, by identifying a potential delivery location and time based on customer calendar schedule data. Subsequently, this embodiment includes determining whether the potential delivery location and time is possible based on whether estimates of a period to assemble a shipment including the products of the order data, a delivery vehicle availability time, and a travel time allow for arrival of the shipment from a shipping location to the potential delivery location at the potential delivery time. When the potential delivery location and time is determined as not possible, the method then determines a different delivery option. Otherwise, when a delivery option is possible, the method includes outputting, via the network to the computing device of the customer, data identifying the potential delivery location and time. The method may then request customer acceptance input with regard to a potential delivery location and time.

A further embodiment, in the form of a system, includes a network interface device, a processor, and a memory storing instructions executable by the processor to perform data processing activities. The data processing activities may include receiving, via the network interface device from a computing device of a customer, order data including data identifying products for purchase and delivery to the customer. The data processing activities further determine a delivery option by identifying a potential delivery location and time based on customer calendar schedule data and determines whether the potential delivery location and time is possible. The possibility of the delivery option may be determined based on whether estimates of a period to assemble a shipment including the products of the order data, a delivery vehicle availability time, and a travel time allow for arrival of the shipment from a shipping location to the potential delivery location at the potential delivery time. When the potential delivery location and time is determined as not possible, a different delivery option may be determined. Otherwise, the data processing activities include outputting, via the network to the computing device of the customer, data identifying the potential delivery location and time and a request for customer acceptance input.

### BRIEF DESCRIPTION OF THE DRAWINGS

FIG. 1 is a logical block diagram of a system, according to an example embodiment.

FIG. 2 is a user interface illustration, according to an example embodiment.

FIG. 3 is a block flow diagram of a method, according to an example embodiment.

FIG. 4 is a block flow diagram of a method, according to an example embodiment.

FIG. 5 is a block diagram of a computing device, according to an example embodiment.

### DETAILED DESCRIPTION

Various embodiments herein each include at least one of systems, methods, and software of order logistics calculators. Such calculators are implemented to determine feasible logistic solutions for product order deliveries. From these logistic solutions, purchased goods may then be gathered, provided to a delivery vehicle, and actually delivered to the customer and in a timely manner conveniently and easily tailored to the customer's schedule. Such embodiments can provide numerous benefits such as reduced in-store and delivery friction for the customer that can degrade their shopping experience, reduced labor costs while increasing productivity, less in-store shrinkage through a reduction of in-store traffic, less door step theft, reduction in store expense in cart and checkout terminal need and staffing, missed deliveries that require a signature, and others.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such

embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

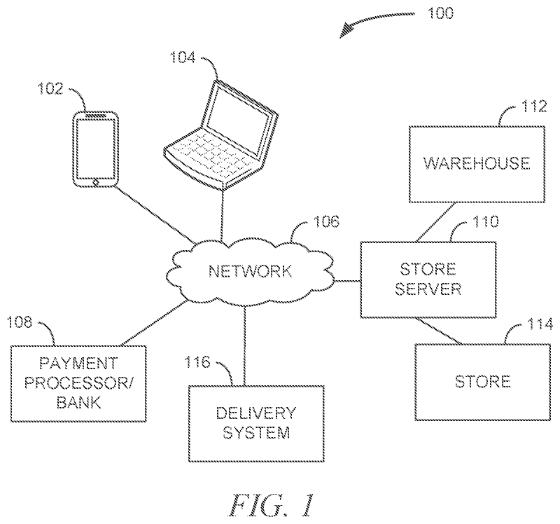

FIG. 1 is a logical block diagram of a system 100, according to an example embodiment. The system 100 is an example of an online commerce system on which some embodiments may be practiced.

The system 100 includes customer devices 102, 104. Although only two customer devices 102, 104 are illustrated, there may be many, many customer devices 102, 104 just as there may be many of the other devices, facilities, networks, payment processors and other financial institutions, delivery systems and vehicles,

and the like as may be used to scale a particular embodiment. Thus, the elements of the system 100 are illustrated and described in a simplified manner to more easily and clearly convey the solutions of the embodiments provided and claimed herein.

The customer devices 102, 104 may be mobile devices such as smartphones, tablets, and smartwatches. The customer devices 102, 104 may also be personal computers, publicly accessible kiosks, television set-top boxes, smart controllers of an automobile, a seatback entertainment device within a vehicle such as an airplane, a self-service checkout terminal at a store, an automated teller machine, and the like.

The customer devices 102, 104 are connected to a network 106, such as the Internet. Also connected to the network are servers of different entities that perform different functions. At least one store server 110 is operated by or for the benefit of a retailer and provides an online retail outlet for products available from one or both of a warehouse 112 and a brick-and-mortar store 114. Note that there may multiple warehouses 112 and multiple stores 114 in various embodiments. The warehouse(s) 112 and store(s) 114 may hold the same or different products in distinct quantities. Thus, when an order to be delivered is received by the store server 110, the order may be filled with products from one or more of these locations.

Also connected to the network 106 are one or more payment processors and banks 108 and one or more delivery servers 116. One such delivery server 116 may perform logistic calculator functions and may be a standalone server 116 or may be integrated within a store server 110. Another delivery server 116 may be operated by and expose services of a delivery service provider (e.g., vehicle availability and time until available, time estimate from shipping pick up location to delivery location, current vehicle location data, pricing data), which may be a different party than an operator of the store server 110, store 114, and warehouse 112. A delivery server 116 may also or alternatively provide a mapping service and other such delivery related services.

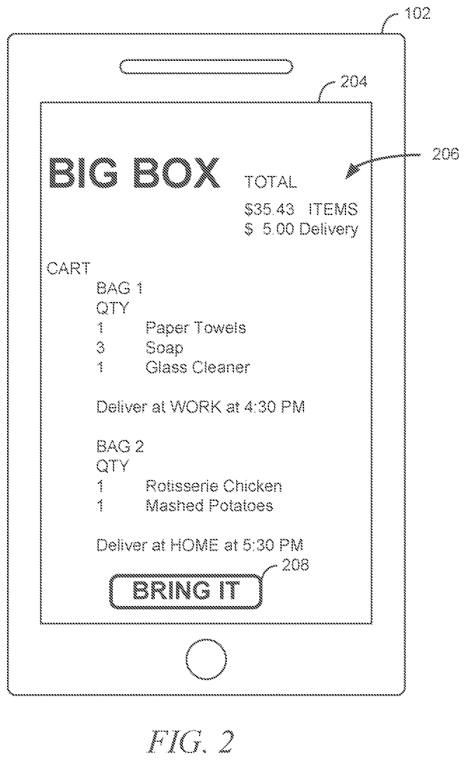

In operation, a user may build an order on customer device 102 through interactions over the network 106 with the store server 110. Once a user has added items to a cart, the cart contents may be presented in a user interface 204, as illustrated in FIG. 2. FIG. 2 illustrates the user interface 204, according to an example embodiment. As illustrated, the user interface shows the cart contents 206 divided into two bags, BAG 1 and BAG 2. This indicates the cart items are not all available from the same shipping location, such as store 114 and warehouse 112 of FIG. 1. Accordingly, the items will need to be gathered separately from each shipping location and then either shipped separately or joined, such as by a delivery vehicle picking up items from one location and then the other prior to delivery. However, in the illustrated user interface 204 are proposed deliveries of BAG 1 with cleaning goods at 4:30 PM at the customer's work location and prepared food items at the customer's home at 5:30 PM.

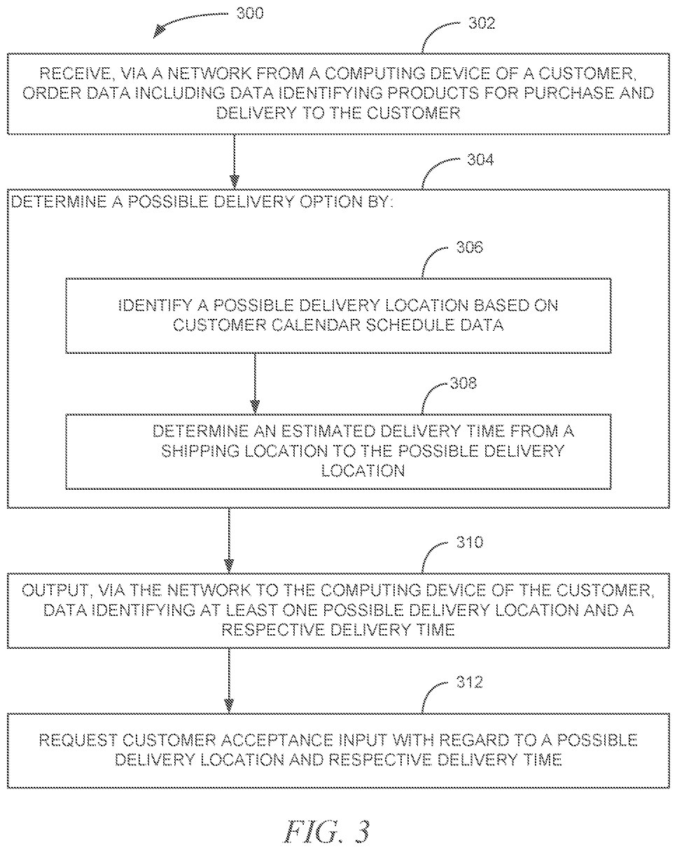

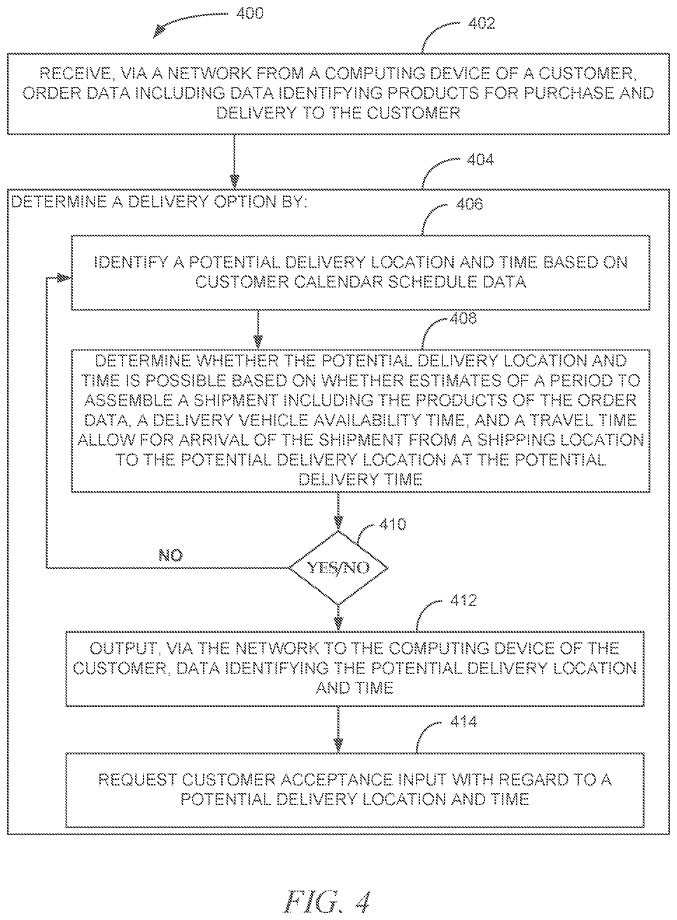

The delivery proposals are determined through interactions of store server 110 processes with processes of at least one delivery server 116 to identify where to deliver the orders, what time the orders might be delivered and what possible order locations and times are possible based on known or predicted locations of the customer. The delivery location and time determinations may be based in part on customer specified preferences, access to customer scheduling data such as by access granted to calendar data stored on a customer device 102 on which the order was generated or access granted by the customer to a network resource storing customer calendar data, e.g., groupware application server, cloud-based calendar and email system. The delivery location and time determinations may also or alternatively be based on a predicted location of the customer generated from one or more of customer Internet search history data and historic customer location data, e.g., as may be predicted by GOOGLE MAPS DRIVING MODE available from GOOGLE, INC. of Mountain View, Calif., and other data that may provide insight into a location where the customer may be located at a particular time in the future. Further detail on various embodiments of how the delivery proposals are determined are described with reference to FIG. 3 and FIG. 4.

The user interface 204 further includes a “BRING IT” selection button 208 to accept the proposed deliveries at the proposed locations and times. Some embodiments may further include an edit or change option to request other delivery locations, times, and whether to instead include the items in a single delivery. Once the user accepts the order and selects the “BRING IT” selection button 208, the store server 110 will interact with at least one payment processor server 108 and the delivery server 116 to schedule the deliveries. A pick list for the ordered items with be provided to staff or an automated warehouse system to gather the products at each location and one or more delivery vehicles will be scheduled. Scheduling the one or more delivery vehicles may include scheduling a vehicle of the store 112 and warehouse 114 operator or requesting a delivery vehicle from one or more third-party services such as ride sharing, food delivery, courier, or other such delivery services. The loading will also be scheduled and the items will be delivered once ordered.

FIG. 3 is a block flow diagram of a method 300, according to an example embodiment. The method 300 is an example method that may be performed for order logistics calculations, such as on a store server 110, delivery server 116, or elsewhere within the system 100 of FIG. 1.

The method 300 includes receiving 302, via a network from a computing device of a customer, order data including data identifying products for purchase and delivery to the customer and determining 304 a possible delivery option. Determining 304 a possible delivery option may include identifying 306 a possible delivery location based on customer calendar schedule data and determining 308 an estimated delivery time from a shipping location to the possible delivery location. The method then continues by outputting 310, via the network to the computing device of the customer, data identifying at least one possible delivery location and a respective delivery time and requesting 312 customer acceptance input with regard to a possible delivery location and respective delivery time. In some embodiments, the presenting of the output 310 data and the requesting of customer input are performed through a customer device 102, 104 user interface 204 as illustrated in and described with regard to FIG. 1 and FIG. 2.

In some embodiments of the method 300, the determining 304 of the possible delivery option further includes determining a shipment ready time from a current time plus an estimated period for assembly of the order data products for shipment from a shipping location. This embodiment further includes determining an arrival time of an available delivery vehicle to pick up a shipment of the products from the shipping location no earlier than the shipment ready time and determining a departure time when the delivery vehicle will depart from the shipping location. Determining the departure time when the delivery vehicle will depart from the shipping location may include adding a period to the arrival time to account for receipt and loading of the shipment into the delivery vehicle. The goal of such embodiments is to account for estimates of the time involved for a vehicle to be requested, arrive, be loaded, and depart. In some embodiments of the method 300, determining 308 the estimated delivery time is determined based on the shipment ready time.

In some embodiments, identifying 306 the possible delivery location, as mentioned above, may be further based on a predicted location of the customer derived from at least one of a customer location history, an internet search history, current date, and day of the week.

Determining 304 a possible delivery option in some embodiments also includes determining a delivery cost of the possible delivery option. The delivery cost may be presented to a user to accept, approve, decline, or take other action. Further, the cost estimate may be automatically approved to declined based on a customer preference of an amount the customer is will or not willing to pay for delivery. The cost estimate may be determined in some embodiments based in part on one or more of a shipment ready time, a distance from the shipping location to the possible delivery location, variable pricing rules such as for peak on non-peak times, actual or predicted traffic along a route between the shipping location and possible delivery location, and a period between the arrival and estimated delivery times, i.e., travel time.

In another embodiment of the method 300, determining 304 a possible delivery option includes performing the determining 304 of a possible delivery option at least twice to obtain a plurality of possible delivery options. Further in such embodiments, outputting 310 the data identifying at least one possible delivery location and a respective delivery time at the possible delivery location includes outputting the plurality of possible delivery options.

FIG. 4 is a block flow diagram of a method 400, according to an example embodiment. The method 400 is another example method that may be performed for order logistics calculations, such as on a store server 110, delivery server 116, or elsewhere within the system 100 of FIG. 1.

The method 400 includes receiving 402, via a network from a computing device of a customer, order data including data identifying products for purchase and delivery to the customer and determining 404 a delivery option. Determining 404 a delivery option may include identifying 406 a potential delivery location and time based on customer calendar schedule data. Determining 404 a delivery option may further include determining 408 whether the potential delivery location and time is possible based on whether estimates of a period to assemble a shipment including the products of the order data, a delivery vehicle availability time, and a travel time allow for arrival of the shipment from a shipping location to the potential delivery location at the potential delivery time.

In such embodiments, when it is determined 408 that the potential delivery location and time is not possible, at 410 the method 400 returns to identifying 406 a potential delivery location and time based on the customer calendar schedule data and further influenced by the potential delivery location and time that was not possible. However, when it is determined 408 that the potential delivery location and time is not possible, at 410 the method 400 proceeds by outputting 412, via the network to the computing device of the customer, data identifying the potential delivery location and time and requests 414 customer acceptance input with regard to a potential delivery location and time.

In some embodiments of the method 400, determining 408 whether the potential delivery location and time is possible includes subtracting, from the potential delivery time, the travel time and a time to load the shipment onto the delivery vehicle to obtain an arrival time for the vehicle at a shipping location. This embodiment further includes querying a delivery vehicle service, either internal to a company performing the method or to a system of a third-party that provide delivery services, of whether a delivery vehicle is available to arrive at the shipping location at the arrival time. In such embodiments, when the subtracting results in an arrival time prior to a current time or the query receives a negative result, the potential delivery location and time are not possible, otherwise, the potential delivery location and time are possible.

In another embodiment of the method 400, determining a delivery option 404 includes performing the determining 404 of a delivery option iteratively to obtain a plurality of possible delivery options and the outputting 412 of the data identifying the potential delivery location and time includes outputting 412 the plurality of potential delivery locations and times.

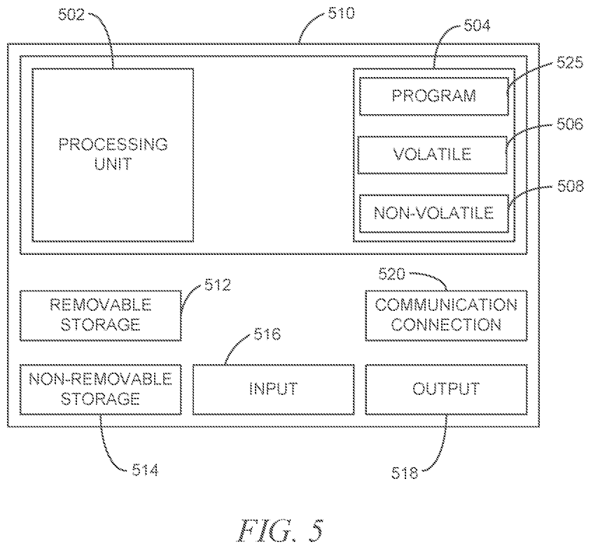

FIG. 5 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Although the example computing device is illustrated and described as computer 510, the computing device may be in different forms in different embodiments. For example, the computing device may instead be a smartphone, a tablet, smartwatch, or other computing device including the same or similar elements as illustrated and described with regard to FIG. 5. Devices such as smartphones, tablets, and smartwatches are generally collectively referred to as mobile devices. Further, although the various data storage elements are illustrated as part of the computer 510, the storage may also or alternatively include cloud-based storage accessible via a network, such as the Internet.

Returning to the computer 510, memory 504 may include volatile memory 506 and non-volatile memory 508. Computer 510 may include—or have access to a computing environment that includes a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 510 may include or have access to a computing environment that includes input 516, output 518, and a communication connection 520. The input 516 may include one or more of a touchscreen, touchpad, mouse, keyboard, camera, one or more device-specific buttons, one or more sensors integrated within or coupled via wired or wireless data connections to the computer 510, and other input devices. The computer 510 may operate in a networked environment using a communication connection 520 to connect to one or more remote computers, such as database servers, web servers, and other computing device. An example remote computer may include a personal computer (PC), server, router, network PC, a peer device or other common network node, or the like. The communication connection 520 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 520 may also or alternatively include a transceiver device, such as a BLUETOOTH® device that enables the computer 510 to wirelessly receive data from and transmit data to other BLUETOOTH® devices.

Computer-readable instructions stored on a computer-readable medium are executable by the processing unit 502 of the computer 510. A hard drive (magnetic disk or solid state), CD-ROM, and RAM are some examples of articles including a non-transitory computer-readable medium. For example, various computer programs 525 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, via a network from a computing device of a customer, order data including data identifying products for purchase and delivery to the customer;
determining a possible delivery option by:
identifying a possible delivery location based on customer calendar schedule data; and
determining an estimated delivery time from a shipping location to the possible delivery location;
outputting, via the network to the computing device of the customer, data identifying at least one possible delivery location and a respective delivery time; and
requesting customer acceptance input with regard to a possible delivery location and respective delivery time.

2. The method of claim 2, the determining of the possible delivery option further comprising:
determining a shipment ready time from a current time plus an estimated period for assembly of the order data products for shipment from a shipping location;
determining an arrival time of an available delivery vehicle to pick up a shipment of the products from the shipping location no earlier than the shipment ready time; and
determining a departure time when the delivery vehicle will depart from the shipping location.

3. The method of claim 2, wherein determining the departure time when the delivery vehicle will depart from the shipping location includes adding a period to the arrival time to account for receipt and loading of the shipment into the delivery vehicle.

4. The method of claim 3, wherein determining the estimated delivery time is determined based on the shipment ready time.

5. The method of claim 1, where the identifying of the possible delivery location is further based on a predicted location of the customer derived from at least one of a customer location history, an interne search history, current date, and day of the week.

6. The method of claim 1, the determining of a possible delivery option further comprising:
determining a delivery cost of the possible delivery option based in part on at least one of:
shipment ready time;
a distance from the shipping location to the possible delivery location;
variable pricing rules;
actual or predicted traffic along a route between the shipping location and possible delivery location; and
a period between the arrival and estimated delivery times.

7. The method of claim 1, wherein:
determining a possible delivery option includes performing the determining of a possible delivery option at least twice to obtain a plurality of possible delivery options; and
outputting the data identifying at least one possible delivery location and a respective delivery time at the possible delivery location includes outputting the plurality of possible delivery options.

8. The method of claim 1, wherein identifying the possible delivery location based on customer calendar schedule data includes receiving data representative of the possible delivery location from the computing device of the customer from which the order data was received, the data representative of the possible delivery location determined on the mobile device based on customer calendar data stored thereon.

9. The method of claim 1, wherein identifying the possible delivery location based on customer calendar schedule data is identified based at least in part on customer calendar data accessed via the network.

10. A method comprising:
receiving, via a network from a computing device of a customer, order data including data identifying products for purchase and delivery to the customer;
determining a delivery option by:
identifying a potential delivery location and time based on customer calendar schedule data;
determining whether the potential delivery location and time is possible based on whether estimates of a period to assemble a shipment including the products of the order data, a delivery vehicle availability time, and a travel time allow for arrival of the shipment from a shipping location to the potential delivery location at the potential delivery time; and
when the potential delivery location and time is determined as not possible, determining a different delivery option, otherwise
outputting, via the network to the computing device of the customer, data identifying the potential delivery location and time; and
requesting customer acceptance input with regard to a potential delivery location and time.

11. The method of claim 10, wherein determining whether the potential delivery location and time is possible includes:
subtracting, from the potential delivery time, the travel time and a time to load the shipment onto the delivery vehicle to obtain an arrival time for the vehicle at a shipping location;
querying a delivery vehicle service of whether a delivery vehicle is available to arrive at the shipping location at the arrival time; and
when the subtracting results in an arrival time prior to a current time or the query receives a negative result, the potential delivery location and time are not possible, otherwise, the potential delivery location and time are possible.

12. The method of claim 11, when the potential delivery location and time is determined as possible, the method further comprising:
determining a delivery cost of the possible delivery option based in part on at least one of:
the arrival time;
a distance from the shipping location to the possible delivery location;
variable pricing rules;
actual or predicted traffic along a route between the shipping location and possible delivery location; and
a period between the arrival and estimated delivery times.

13. The method of claim 10, wherein identifying the possible delivery location and time is further based on a predicted location of the customer derived from at least one of a customer location history, an interne search history, current date, and day of the week.

14. The method of claim 10, wherein:
determining a delivery option includes performing the determining of a delivery option iteratively to obtain a plurality of possible delivery options; and
outputting the data identifying the potential delivery location and time includes outputting the plurality of potential delivery locations and times.

15. The method of claim 10, wherein identifying the potential delivery location based on customer calendar schedule data includes receiving data representative of the potential delivery location from the computing device of the customer from which the order data was received, the data representative of the potential delivery location determined on the mobile device based on customer calendar data stored thereon.

16. The method of claim 10, wherein identifying the potential delivery location based on customer calendar schedule data is identified based at least in part on customer calendar data accessed via the network.

17. A system comprising:
a network interface device;
a processor;
a memory storing instructions executable by the processor to perform data processing activities comprising:
receiving, via the network interface device from a computing device of a customer, order data including data identifying products for purchase and delivery to the customer;
determining a delivery option by:
identifying a potential delivery location and time based on customer calendar schedule data;
determining whether the potential delivery location and time is possible based on whether estimates of a period to assemble a shipment including the products of the order data, a delivery vehicle availability time, and a travel time allow for arrival of the shipment from a shipping location to the potential delivery location at the potential delivery time; and
when the potential delivery location and time is determined as not possible, determining a different delivery option, otherwise
outputting, via the network to the computing device of the customer, data identifying the potential delivery location and time; and
requesting customer acceptance input with regard to a potential delivery location and time.

18. The system of claim 17, wherein determining whether the potential delivery location and time is possible includes:
subtracting, from the potential delivery time, the travel time and a time to load the shipment onto the delivery vehicle to obtain an arrival time for the vehicle at a shipping location;
querying a delivery vehicle service of whether a delivery vehicle is available to arrive at the shipping location at the arrival time; and
when the subtracting results in an arrival time prior to a current time or the query receives a negative result, the potential delivery location and time are not possible, otherwise, the potential delivery location and time are possible.

19. The system of claim 18, when the potential delivery location and time is determined as possible, the method further comprising:
determining a delivery cost of the possible delivery option based in part on at least one of:
the arrival time;
a distance from the shipping location to the possible delivery location;
variable pricing rules;
actual or predicted traffic along a route between the shipping location and possible delivery location; and
a period between the arrival and estimated delivery times.

20. The system of claim 17, wherein:
determining a delivery option includes performing the determining of a delivery option iteratively to obtain a plurality of possible delivery options; and
outputting the data identifying the potential delivery location and time includes outputting the plurality of potential delivery locations and times.
